(19) United States
(12) Patent Application Publication
(10) Pub. No.: US 2009/0262493 A1
(43) Pub. Date: Oct. 22, 2009

(54) Digital picture frame

(76) Inventors: Chih-Ying Lee, Taipei (TW); Hung-Hsi Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,180

(22) Filed: Jul. 1, 2008

(30) Foreign Application Priority Data
Apr. 18, 2008 (CN) 200810087582.6

(51) Int. Cl. G06F 1/16

(52) U.S. Cl. 361/679.21

(57) ABSTRACT

A digital picture frame includes a display unit connected movably to a base, a driving unit operable so as to drive the display unit to move relative to the base between a lengthwise position and a widthwise position, an input unit operable so as to generate a control signal, and a controller connected electrically to the input unit and the driving unit. The controller controls the driving unit in response to the control signal from the input unit so that the display unit is driven by the driving unit to move from a current one of the lengthwise position and the widthwise position to the other one of the lengthwise position and the widthwise position.

### CROSS-REFERENCE TO RELATED APPLICATION

This application claims priority of Chinese Application No. 200810087582.6, filed on Apr. 8, 2000.

### BACKGROUND OF THE INVENTION

1. Field of the Invention

The invention relates to a digital picture frame, more particularly to a digital picture frame having a movable display unit.

2. Description of the Related Art

Referring to FIG. 1, a conventional digital picture frame 1 is shown to include a display 11 for displaying digital image data thereon, and a prop 12 connected to the display 11 for supporting the display 11. The digital image data displayed on the display 11 as a digital picture can be that of a portrait or a landscape. The conventional digital picture frame 1 is operable between one of a widthwise position, where a display screen of the display 1 has a width, and a length shorter than the width, and a lengthwise position, where the display screen of the display 1 has a length, and a width shorter than the length. In order to obtain proper presentation of the digital image data, while it is possible to manually adjust the conventional digital image frame 1 to an appropriate one of the widthwise and lengthwise positions corresponding to the digital image data being displayed, such manual adjustment is inconvenient for users.

### SUMMARY OF THE INVENTION

Therefore, the object of the present invention is to provide a digital picture frame that can overcome the aforesaid drawbacks of the prior art.

According to the present invention, a digital picture frame comprises:

a base;

a display unit connected movably to the base;

a driving unit operable so as to drive the display unit to move relative to the base between a lengthwise position and a widthwise position;

an input unit operable so as to generate a control signal; and

a controller connected electrically to the input unit and the driving unit, the controller controlling the driving unit in response to the control signal from the input unit so that the display unit is driven by the driving unit to move from a current one of the lengthwise position and the widthwise position to the other one of the lengthwise position and the widthwise position.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional digital picture frame;

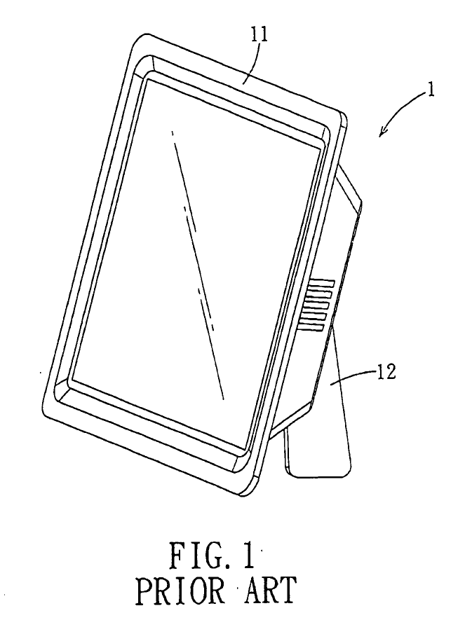

FIG. 2 is a schematic side view showing the first preferred embodiment of a digital picture frame according to the present invention;

FIG. 3 is a schematic circuit block diagram illustrating the first preferred embodiment;

FIG. 4 is a schematic view showing the first preferred embodiment when a display unit is at a lengthwise position;

FIG. 5 is a schematic view showing the first preferred embodiment when the display unit is at a widthwise position;

FIG. 6 is a schematic view showing the second preferred embodiment of a digital picture frame according to the present invention when a display unit is at a lengthwise position;

FIG. 7 is a schematic view showing the second preferred embodiment when the display unit is at a widthwise position;

FIG. 8 is a schematic view showing the third preferred embodiment of a digital picture frame according to the present invention when a display unit is at a widthwise position;

FIG. 9 is a schematic view showing the third preferred embodiment when the display unit is at a lengthwise position;

FIG. 10 is a schematic view showing the fourth preferred embodiment of a digital picture frame according to the present invention when a display unit is at a widthwise position;

FIG. 11 is a schematic view showing the fourth preferred embodiment when the display unit is at a lengthwise position;

FIG. 12 is a schematic view showing the fifth preferred embodiment of a digital picture frame according to the present invention when a display unit is at a widthwise position;

FIG. 13 is a schematic view showing the fifth preferred embodiment when the display unit is at a lengthwise position;

FIG. 14 is a schematic view showing the sixth preferred embodiment of a digital picture frame according to the present invention;

FIG. 15 is a schematic side view showing the sixth preferred embodiment; and

FIG. 16 is a schematic front view showing the seventh preferred embodiment of a digital picture frame according to the present invention.

### DETAILED DESCRIPTION OF THE PREFERRED EMBODIMENTS

Before the present invention is described in greater detail, it should be noted that like elements are denoted by the same reference numerals throughout the disclosure.

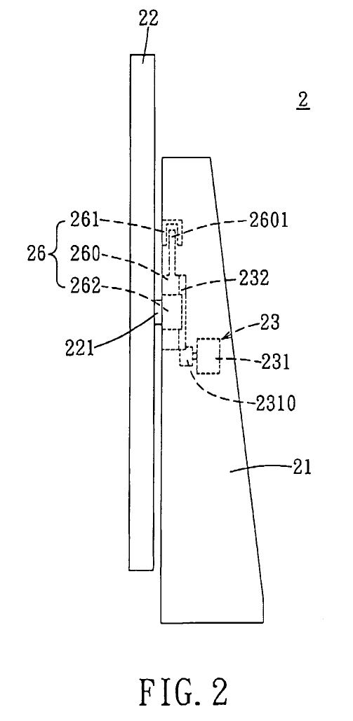

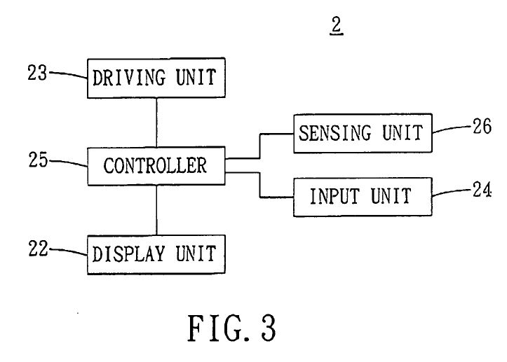

Referring to FIGS. 2 to 5, the first preferred embodiment of a digital picture frame 2 according to the present invention is shown to include a base 21, a display unit 22, a driving unit 23, an input unit 24, a controller 25, and a sensing unit 26.

The display unit 22 is connected movably to the base 21. In this embodiment, the display unit 22 is disposed on a front side of the base 21, and has a connecting member 221, such as a connecting rod, connected pivotally to the base 21.

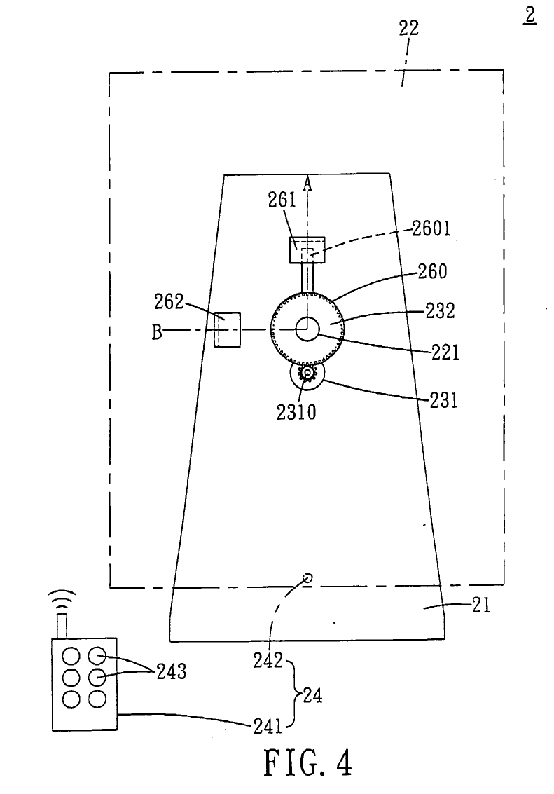

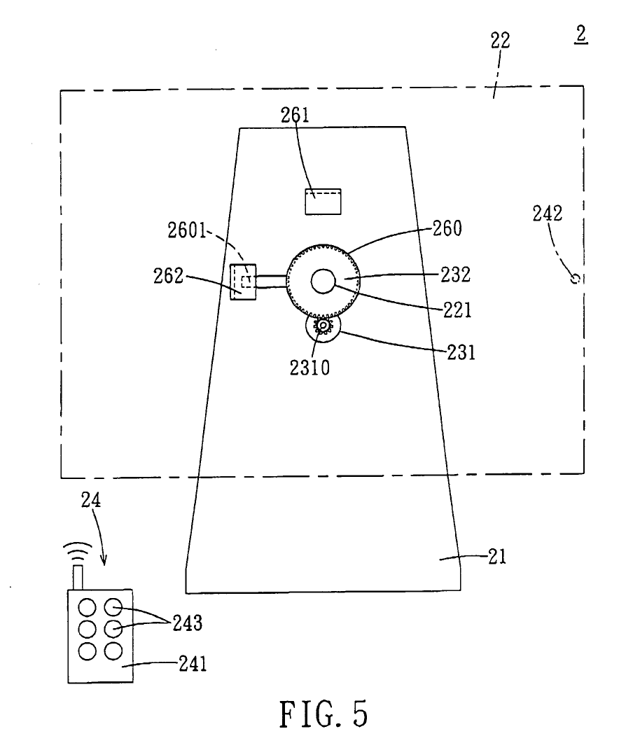

The driving unit 23 is operable so as to drive the display unit 22 to rotate relative to the base 21 about the connecting member 221 between a lengthwise position, where the display unit 22 has a length larger than a width thereof (see FIG. 4), and a widthwise position, where the display unit 22 has a width larger than a length thereof (see FIG. 5). In this embodiment, the driving unit 23 is disposed in the base 21, and includes a motor 231 and a driven gear 232. The motor 231 has a motor shaft 2310. The driven gear 232 meshes with the motor shaft 2310 of the motor 231, and is connected to the connecting member 221 of the display unit 22 such that the connecting member 221 co-rotates with the driven gear 232 in response to operation of the motor 231.

The input unit 24 is operable so as to generate a control signal. In this embodiment, as shown in FIG. 4, the input unit 24 includes a wireless signal transmitter 241, such as an infrared signal transmitter, separate from the display unit 22 and the base 21, and a wireless signal receiver 242, such as an infrared signal receiver, mounted in the display unit 22. The wireless signal transmitter 241 has a plurality of control keys 243. It is noted that the signal receiver 242 may be mounted to the base 21 in other embodiments of the invention

The controller 25 is connected electrically to the driving unit 22 and the wireless signal receiver 242 of the input unit 24. The controller 25 controls the driving unit 23 in response to the control signal from the input unit 24 so that the display unit 22 is driven by the driving unit 23 to move from a current one of the lengthwise position and the widthwise position to the other one of the lengthwise position and the widthwise position. It is noted that the display unit 22 moves from one of the lengthwise position and the widthwise position to the other one of the lengthwise position and from the other one of the lengthwise position and the widthwise position to said one of the lengthwise position and the widthwise position in two opposite directions, respectively, such as clockwise and counterclockwise directions.

Referring further to FIGS. 4 and 5, the sensing unit 26 is connected electrically to the controller 25 or detecting whether the display unit 22 is at the lengthwise position or the widthwise position. In this embodiment, the sensing unit 26 includes first and second position sensors 261, 262 corresponding respectively to the lengthwise position and the widthwise position, and a driven member 260. The first and second position sensors 261, 262 are preferably infrared sensors, and are disposed spacedly at the base 21 (see FIG. 2) so that a first extension line (A) passing through the first position sensor 261 and the connecting member 221 is perpendicular to a second extension line (B) passing through the second position sensor 262 and the connecting member 221, as shown in FIG. 4. Each of the first and second position sensors 261, 262 outputs a sensing signal to the controller 25 upon detecting that the display unit 22 is at a corresponding one of the lengthwise position and the widthwise position. The driven member 260 is connected to and is co-rotatable with the connecting member 221 of the display unit 22 in this embodiment. The driven member 260 has a free end 2601 sensed by one of the first and second position sensors 261, 262 when the display unit 22 is moved to one of the lengthwise position and the widthwise position.

More specifically, as shown in FIG. 4, when the display unit 22 is moved to the lengthwise position, the free end 2601 of the driven member 260 is sensed by the first position sensor 261, which outputs the sensing signal to the controller 25. On the other hand, as shown in FIG. 5, when the display unit 22 is moved to the widthwise position, the free end 2601 of the driven member 260 is sensed by the second position sensor 262, which outputs the sensing signal to the controller 25.

In sum, due to the presence of the driving unit 23, the display unit 22 can be easily moved to a desired one of the lengthwise position and the widthwise position through operation of the input unit 24, thereby resulting in convenience during use.

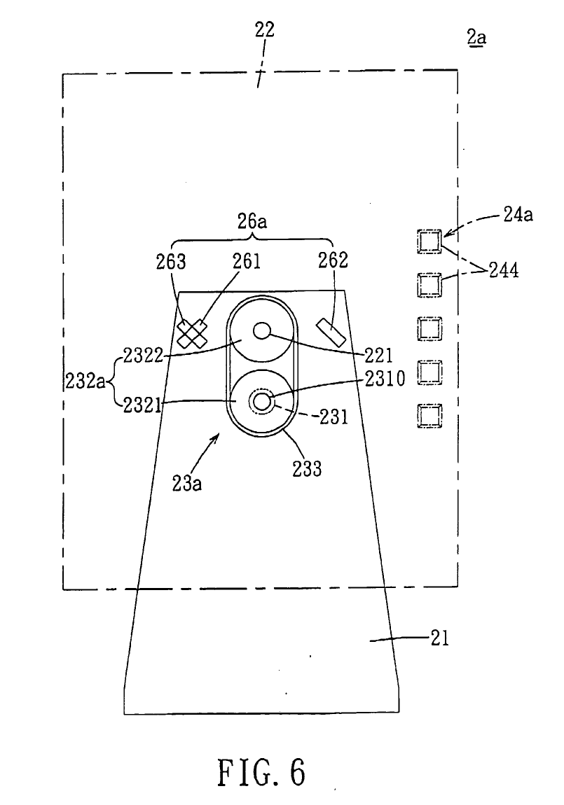

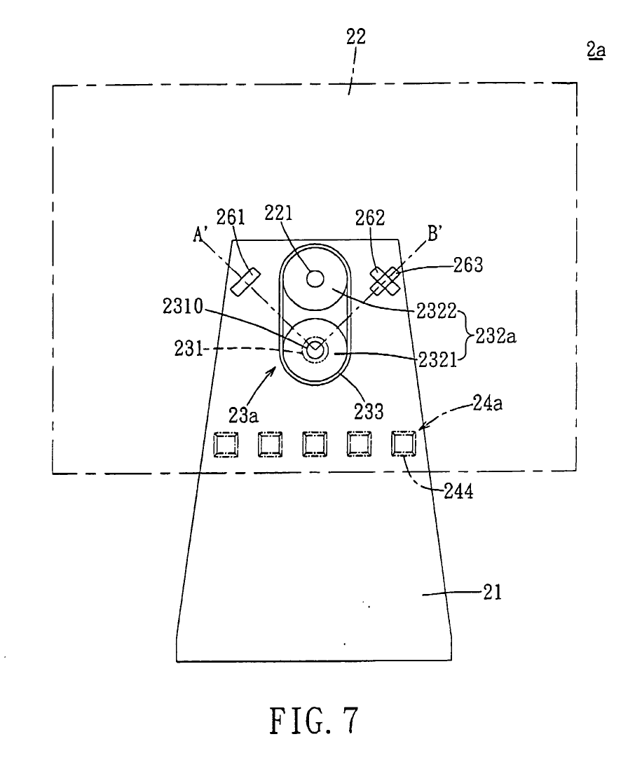

FIGS. 6 and 7 illustrate the second preferred embodiment of a digital picture frame (2a) according to this invention, which is a modification of the first preferred embodiment. Unlike the previous embodiment, the driving unit (23a) includes the motor 231, a transmission wheel set (232a), and a transmission belt 233. The transmission wheel set (232a) includes a driven wheel 2321 connected to the motor shaft 2310 of the motor 231, and a follower wheel 2322 spaced apart from the driven wheel 2321 and connected to the connecting member 221 of the display unit 22 such that the connecting member 221 of the display unit 22 co-rotates with the follower wheel 2322. The transmission belt 233 is trained on the transmission wheel set (232a) and is driven the transmission wheel unit (232a) in response to operation of the motor 231.

The sensing unit (26a) includes the first and second position sensors 261, 262, and a sensed block 263. In this embodiment, the first and second position sensors 261, 262 are mounted spacedly on the front side of the base 21 so that an extension line (A′) passing through the first position sensor 261 and the motor shaft 2310 of the motor 231 is perpendicular to an extension line (B′) passing through the second position sensor 262 and the motor shaft 2310 of the motor 231, as shown in FIG. 7. The sensed block 263 is mounted on a rear side of the display unit 22 and is sensed by one of the first and second position sensors 261, 262 when the display unit 22 is moved to one of the lengthwise position and the widthwise position.

In this embodiment, the input unit (24a) includes a plurality of control keys 244 mounted on the display unit 22. In other embodiments, the control keys 244 can be mounted on the base 21.

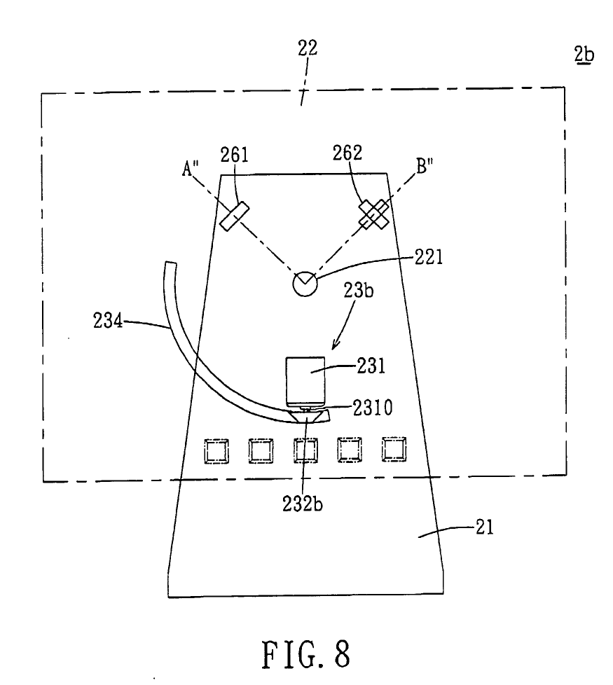

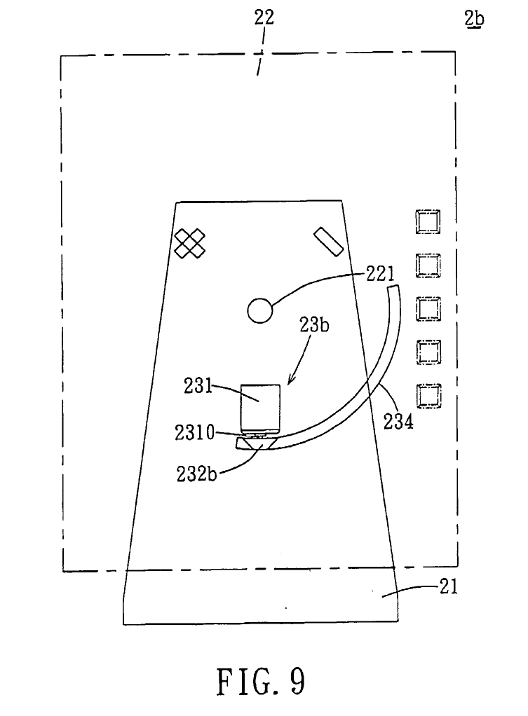

FIGS. 8 and 9 illustrate the third preferred embodiment of a digital picture frame (2b) according to this invention, which is a modification of the second preferred embodiment.

In this embodiment, the connecting member 221 of the display unit 22 can be a connecting rod, a connecting ball or a connecting joint.

In this embodiment, the driving unit (23b) includes the motor 231, a driven bevel gear (232b), and a curved rack 234. The motor 231 is mounted on the front side of the base 21. The driven bevel gear (232b) is connected to the motor shaft 2310 of the motor 231. The curved rack 234 is mounted on the rear side of the display unit 22, and meshes with the driven bevel gear (232b) such that an assembly of the rack 234 and the display unit 22 rotates about the connecting member 221 in response to operation of the motor 231.

Furthermore, the first and second position sensors 261, 262 are mounted spacedly on the front side of the base 21 so that an extension line (A″) passing through the first position sensor 261 and the connecting member 221 is perpendicular to an extension line (B″) passing through the second position sensor 262 and the connecting member 221, as shown in FIG. 8.

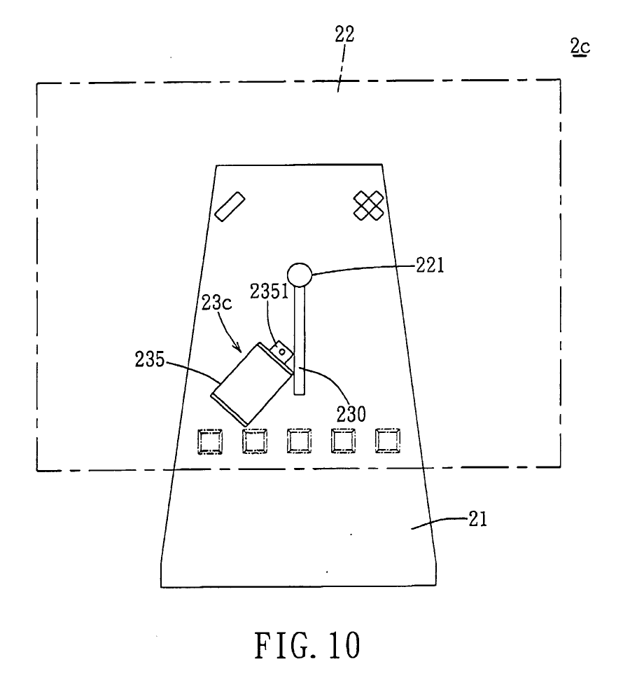

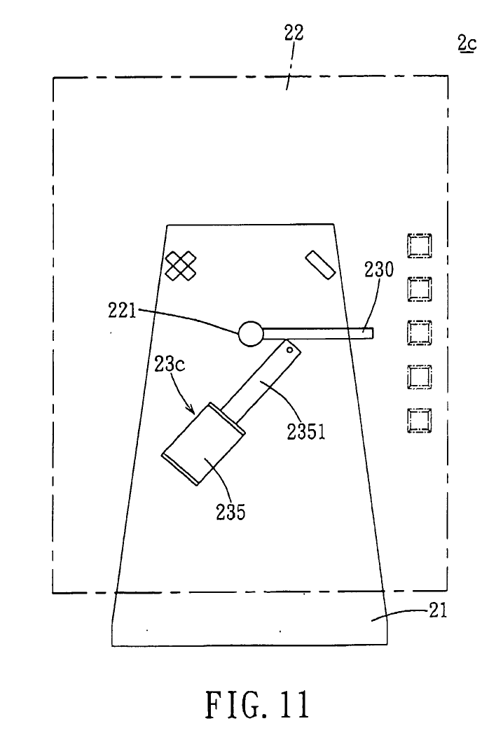

FIGS. 10 and 11 illustrate the fourth preferred embodiment of a digital picture frame (2c) according to this invention, which is a modification of the third preferred embodiment.

In this embodiment, the driving unit (23c) includes a loading rod 230 and a driving member 235. The loading rod 230 is connected to and extends radially from the connecting member 221 of the display unit 22. The driving member 235, such as a solenoid, is mounted on the front side of the base 21, and has an extendible supporting rod 2351 that acts on the loading rod 230. The driving member 235 is operable so as to drive the supporting rod 2351 to move between extended and retracted positions such that an assembly of the loading rod 230 and the display unit 22 is supported by the supporting rod 2351 to rotate about the connecting member 221.

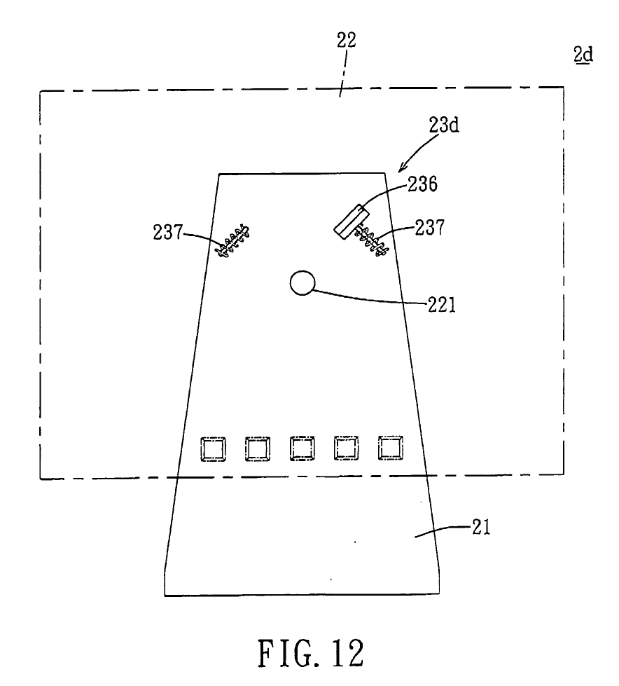

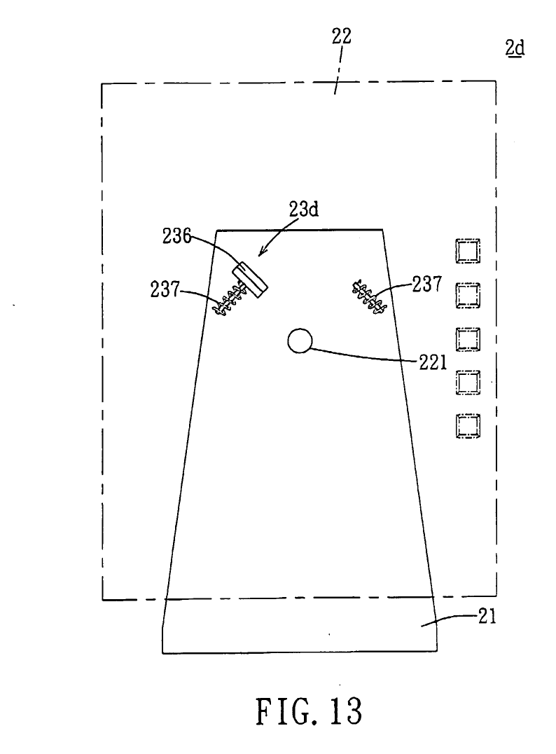

FIGS. 12 and 13 illustrate the fifth preferred embodiment of a digital picture frame (2d) according to this invention, which is a modification of the fourth preferred embodiment. In this embodiment, the sensing unit is not required, and the driving unit (23d) includes a permanent magnet 236 and two electromagnets 237. The permanent magnet 236 is mounted on the rear side of the display unit 22. The electromagnets 237 are mounted spacedly on the front side of the base 21, and are energized so that one of the electromagnets 237 repels and the other one of the electromagnets 237 attracts the permanent magnet 236, thereby rotating an assembly of the permanent magnet 236 and the display unit 22 about the connecting member 221.

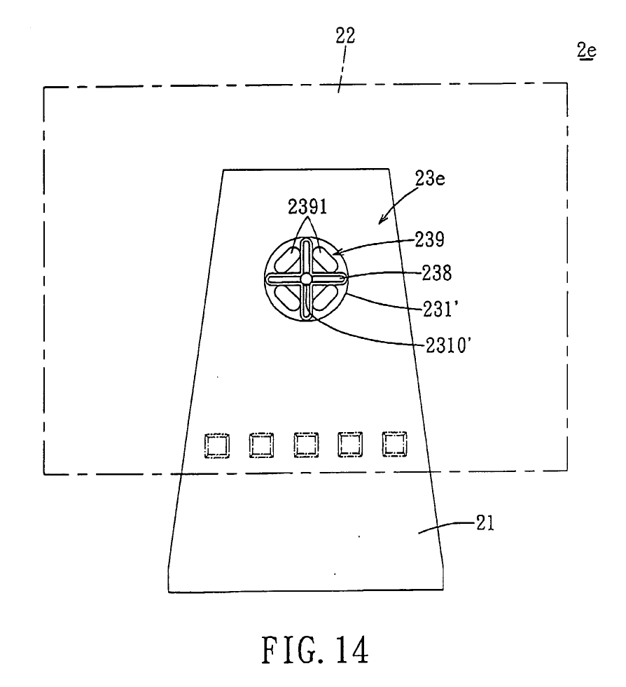

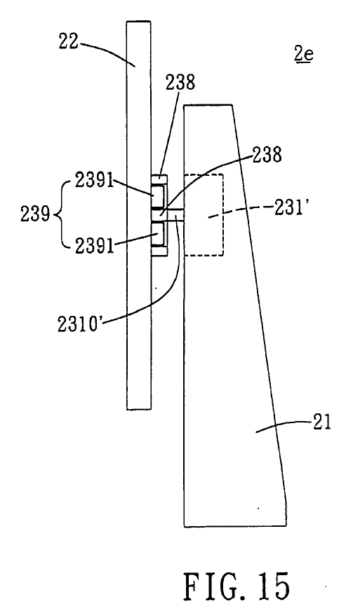

FIGS. 14 and 15 illustrate the sixth preferred embodiment of a digital picture frame (2e) according to this invention, which is a modification of the second preferred embodiment. In this embodiment, the sensing unit and the connecting member of the display unit 22 are not required. The driving unit (23e) includes a stepping motor 231′ mounted in the base 21 and having a motor shaft 2310′ extending outwardly of the base 21, a first engaging member 238 connected to an end of the motor shaft 2310′, and a second engaging member 239 mounted on the rear side of the display unit 22 and engaging the first engaging member 238 such that an assembly of the display unit 22 and the second engaging member 239 co-rotates with the first engaging member 238 in response to operation of the stepping motor 231′. In this embodiment, the first engaging member 238 is in the form of a cross, and the second engaging member 239 includes a plurality of engaging protrusions 2391 spaced apart from each other.

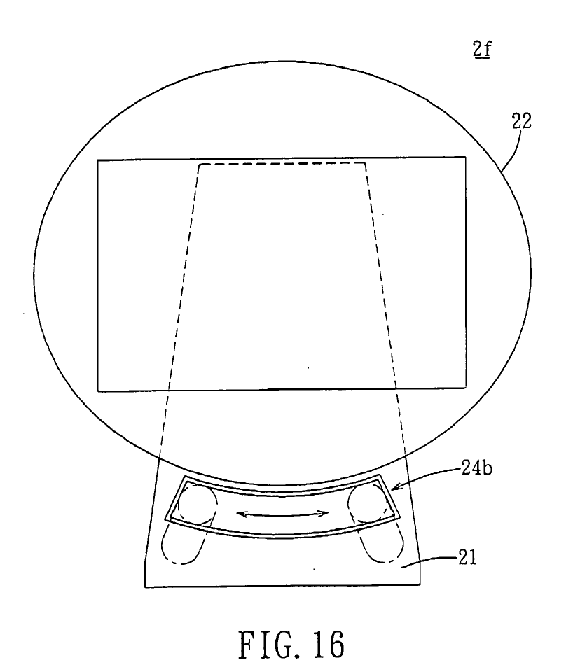

FIG. 16 illustrates the seventh preferred embodiment of a digital picture frame (2f) according to this invention, which is a modification of the first preferred embodiment. In this embodiment, the input unit includes a touch control panel (24b) mounted on the front side of the base 22. By sliding a finger along the touch control panel (24b), an appropriate control signal is generated for enabling the controller (not shown) to control the driving unit (not shown) and move the display unit 22 from a current one of the lengthwise position and the widthwise position to the other one of the lengthwise position and the widthwise position. It is noted that the touch control panel (24b) may be provided on the display unit 22 in other embodiments of the invention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A digital picture frame comprising:
a base;
a display unit connected movably to said base;
a driving unit operable so as to drive said display unit to move relative to said base between a lengthwise position and a widthwise position;
an input unit operable so as to generate a control signal; and
a controller connected electrically to said input unit and said driving unit, said controller controlling said driving unit in response to the control signal from said input unit so that said display unit is driven by said driving unit to move from a current one of the lengthwise position and the widthwise position to the other one of the lengthwise position and the widthwise position.

2. The digital picture frame as claimed in claim 1, wherein:
said display unit has a connecting member connected pivotally to said base; and
said driving unit drives said display unit to rotate relative to said base about said connecting member.

3. The digital picture frame as claimed in claim 2, wherein said driving unit is disposed in said base, and includes:
a motor having a motor shaft; and
a driven gear meshing with said motor shaft of said motor, and connected to said connecting member of said display unit such that said connecting member of said display unit co-rotates with said driven gear in response to operation of said motor.

4. The digital picture frame as claimed in claim 2, wherein said driving unit is disposed in said base, and includes:
a motor having a motor shaft;
a transmission wheel set including a driven wheel connected to said motor shaft of said motor, and a follower wheel spaced apart from said driven wheel and connected to said connecting member of said display unit such that said connecting member of said display unit co-rotates with said follower wheel; and
a transmission belt trained on said transmission wheel set and driven by said transmission wheel set in response to operation of said motor.

5. The digital picture frame as claimed in claim 2, wherein said driving unit includes:
a motor mounted on said base and having a motor shaft;
a driven bevel gear connected to said motor shaft of said motor; and
a curved rack mounted on said display unit and meshing with said driven bevel gear such that an assembly of said rack and said display unit rotates about said connecting member in response to operation of said motor.

6. The digital picture frame as claimed in claim 2, wherein said driving unit includes:
a loading rod connected to said display unit; and
a driving member mounted on said base and having an extendible supporting rod that acts on said loading rod, said driving member being operable so as to drive said supporting rod to move between extended and retracted positions such that an assembly of said loading rod and said display unit is supported by said supporting rod to rotate about said connecting member.

7. The digital picture frame as claimed in claim 6, wherein said driving member is a solenoid.

8. The digital picture frame as claimed in claim 2, wherein said driving unit includes:
a permanent magnet mounted on said display unit; and
two electromagnets mounted spacedly on said base, and energized so that one of said electromagnets repels and the other one of said electromagnets attracts said permanent magnet, thereby rotating an assembly of said permanent magnet and said display unit about said connecting member.

9. The digital picture frame as claimed in claim 2, further comprising a sensing unit connected electrically to said controller for detecting whether said display unit is at the lengthwise position or the widthwise position.

10. The digital picture frame as claimed in claim 9, wherein said sensing unit includes:
first and second position sensors disposed spacedly at said base so that a first extension line passing through said first position sensor and said connecting member is perpendicular to a second extension line passing through said second position sensor and said connecting member, each of said first and second position sensors outputting a sensing signal to said controller upon detecting that said display unit is at a corresponding one of the lengthwise position and the widthwise position; and
a driven member connected to said display unit, said driven member having a free end sensed by one of said first and second position sensors when said display unit is moved to one of the lengthwise position and the widthwise position.

11. The digital picture frame as claimed in claim 9, wherein said sensing unit includes:
first and second position sensors mounted spacedly on said base, each of said first and second position sensors outputting a sensing signal to said controller upon detecting that said display unit is at a corresponding one of the lengthwise position and the widthwise position; and
a sensed block mounted on said display unit and sensed by one of said first and second position sensors when said display unit is moved to one of the lengthwise position and the widthwise position.

12. The digital picture frame as claimed in claim 1, wherein said driving unit includes:
a stepping motor mounted in said base and having a motor shaft extending outwardly of said base;
a first engaging member connected to an end of said motor shaft; and
a second engaging member mounted on said display unit and engaging said first engaging member such that an assembly of said display unit and said second engaging member co-rotates with said first engaging member in response to operation of said stepping motor.

13. The digital picture frame as claimed in claim 1, wherein said input unit includes a plurality of control keys mounted on one of said base and said display unit.

14. The digital picture frame as claimed in claim 1, wherein said input unit includes a wireless signal transmitter separate from said display unit and said base, and a wireless signal receiver mounted to one of said base and said display unit and coupled to said controller.

15. The digital picture frame as claimed in claim 1, wherein said input unit includes a touch control panel mounted on one of said base and said display unit.
